(19) United States
(12) Patent Application Publication
(10) Pub. No.: US 2024/0043699 A1
(43) Pub. Date: Feb. 8, 2024

(54) DISPERSION AND COATINGS DERIVED THEREFROM

(71) Applicant: UNIVERSITY OF MASSACHUSETTS, Boston, MA (US)

(72) Inventors: Shane Taylor, Amherst, MA (US); Lei Zheng, Sunderland, MA (US); John Klier, Norman, OK (US)

(21) Appl. No.: 18/227,569

(22) Filed: Jul. 28, 2023

Related U.S. Application Data
(60) Provisional application No. 63/394,340, filed on Aug. 2, 2022.

(51) Int. Cl. C09D 5/02; C09D 7/45; C09D 7/63; C09D 7/61; C09D 133/12

(52) U.S. Cl. CPC C09D 5/022; C09D 5/027; C09D 5/028; C09D 7/45; C09D 7/63; C09D 7/61; C09D 133/12; C08K 2003/2241

(57) ABSTRACT

A dispersion includes a plurality of polymer particles, a plurality of inorganic particles, or a combination thereof dispersed in an aqueous solution, wherein the polymer particles, the inorganic particles, or the combination thereof are substantially insoluble in the aqueous solution. At least a portion of the surface of each particle includes one or more functional surfactants disposed on the surface of the particle. The functional surfactants include a C₁₈₋₃₂ alkyl group; and at least one functional group that is a sulfonate group, a phosphate group, a ureido group, an acetoacetoxy group, a carboxylate group, a C₁₋₁₂ fluorocarbon group, a zwitterionic group, a polyether group, a sugar group, a quaternary ammonium group, or a combination thereof. The dispersions can be useful in the preparation of coatings.

### CROSS REFERENCE TO RELATED APPLICATION

This application claims priority to and the benefit of U.S. Provisional Patent Application No. 63/394,340, filed on Aug. 2, 2022, the contents of which are hereby incorporated by reference in their entirety.

### BACKGROUND

Emulsion polymers and polymer dispersions are formulation components comprising small polymer particles widely used for coatings, adhesives, binders and many other applications. They are typically produced by emulsion polymerization of vinyl monomers (butyl acrylate, methyl methacrylate, styrene and others) or by dispersion of pre-formed polymers (polyurethane dispersions, epoxy dispersions). The performance of emulsion polymers and polymer dispersions in applications is often determined by the surface functionality of the particles which is commonly introduced via functional co-monomers during the polymerization process. However, the most common and lowest cost emulsion polymers and polymer dispersions are made without functional co-monomers, which introduce complexity and cost to the polymerization process.

Accordingly, it would be particularly advantageous to provide an improved method for providing functionalized dispersions, in particular without the need for a functional co-monomer to be included during polymerization for dispersions including polymer particles. Further, it would be particularly advantageous to provide new coating compositions from functionalized dispersions that address the above-described technical limitations

### BRIEF SUMMARY

One embodiment is a dispersion comprising a plurality of polymer particles, a plurality of inorganic particles, or a combination thereof dispersed in an aqueous solution, wherein the polymer particles, the inorganic particles, or the combination thereof are substantially insoluble in the aqueous solution; wherein one or more functional surfactants are disposed on at least a portion of a surface of the polymer particle or the inorganic particle; wherein each functional surfactant comprises a C₁₈₋₃₂ alkyl group; and at least one functional group comprising a sulfonate group, a phosphate group, a ureido group, an acetoacetoxy group, a carboxylate group, a C₁₋₁₂ fluorocarbon group, a zwitterionic group, a polyether group, a sugar group, a quaternary ammonium group, or a combination comprising at least one of the foregoing.

Another embodiment is a method of making the dispersion comprising forming the polymer particle in the presence of the functional surfactant.

Another embodiment is a method of making the dispersion comprising dispersing a plurality of polymer particles, a plurality of inorganic particles, or a combination thereof in water to form a dispersion; and adding the functional surfactant to the dispersion.

A coating composition comprises a dispersion, the dispersion comprising: a plurality of polymer particles dispersed in an aqueous solution, wherein the polymer particles are substantially insoluble in the aqueous solution; wherein one or more functional surfactants are disposed on at least a portion of a surface of the polymer particle; wherein each functional surfactant comprises a C₁₈₋₃₂ alkyl group; and at least one functional group comprising a sulfonate group, a phosphate group, a ureido group, an acetoacetoxy group, a carboxylate group, a C₁₋₁₂ fluorocarbon group, a zwitterionic group, a polyether group, a sugar group, a quaternary ammonium group, or a combination comprising at least one of the foregoing.

A coating derived from the coating composition is also described

These and other embodiments are described in detail below.

### BRIEF DESCRIPTION OF THE DRAWINGS

Referring now to the drawings which represent exemplary embodiments:

FIG. 1 is a schematic illustration representing functionalization of a polymer particle during polymerization to form the polymer particle.

FIG. 2 is a schematic illustration representing functionalization of a polymer particle post-polymerization.

FIG. 3A shows conductivity vs. temperature of a high molecular weight sulfonate surfactant at two concentrations.

FIG. 3B shows conductivity vs. temperature of a high molecular weight phosphonate surfactant (circles) compared to sodium dodecyl phosphate (squares).

FIG. 4A shows size distribution results from dynamic light scattering (DLS) measurements for high molecular weight surfactants dispersed in water using a method as described in the working examples.

FIG. 4B shows size distribution results from dynamic light scattering (DLS) measurements for high molecular weight surfactants dispersed in water using a method as described in the working examples.

FIG. 5 shows pH stability test of latexes of System 1A (SF-Lat1 with no added surfactant), and System 1B (SF-Lat1 functionalized with 0.3 wt % high molecular weight sulfonate surfactant.

FIG. 6 shows pH stability test of latexes of System 2A (SDS-Lat2 with no added surfactant), System 2B (SDS-Lat2 treated with sodium dodecyl phosphate (equivalent molar concentration of System 2C), and System 2C (SDS-Lat2 latex functionalized with 1.0 wt % high molecular weight phosphate surfactant).

FIG. 7 shows a schematic illustration of a dialysis experiment using conventional surfactant (left) compared to high molecular weight surfactant (right).

FIG. 8 shows zeta potential of latex dialyzed for 500 hours.

FIG. 9 shows particle size of a latex system in aqueous hydrochloric acid at pH 3 before and after dialysis.

FIG. 10 shows pH stability test of untreated SDS-Lat2 (“Bare”) and SDS-Lat2 functionalized with high molecular weight phosphate surfactant (“C24P”) over time at elevated temperatures.

FIG. 11A shows scanning electron microscope (SEM) images of dried titania-latex systems for SDS-Lat1.

FIG. 11B shows scanning electron microscope (SEM) images of dried titania-latex systems for SDS-Lat1 treated with high molecular weight phosphate.

FIG. 11C shows scanning electron microscope (SEM) images of FIG. 11B with digital measurement of TiO₂ particle.

FIG. 11D shows scanning electron microscope (SEM) images of FIG. 11B with digital measurement of polymer nanoparticle.

FIG. 12 shows size distribution results from dynamic light scattering (DLS) measurements for TiO₂ mixed with SDS-Lat2 (top), SDS-Lat2 treated with sodium dodecyl phosphate (middle), and SDS-Lat2 latex treated with high molecular weight phosphate surfactant (bottom).

FIG. 13A shows a comparison of percent associated polymer in a latex-TiO₂ system as a function of high molecular weight phosphate surfactant concentration.

FIG. 13B shows a visual comparison of sedimentation lines for latex-TiO₂ systems containing 0.0-1.0 wt % high molecular weight phosphate surfactant (from left to right, 0.0%, 0.1%, 0.5%, and 1.0% of surfactant).

FIG. 13C shows latex association for a latex system functionalized with high molecular weight phosphate surfactant before and after synthesis.

FIG. 13D shows latex association percentages for latex systems functionalized with high molecular weight phosphate surfactant at room temperature and 80° C.

FIG. 14 shows a graph showing a decrease in settling velocity according to Stoke's Law for an unencapsulated particle (i.e. 320 nm TiO₂ particle with a 0 nm latex particle size attached) and for TiO₂ encapsulated with variously sized latex particles up to 300 nm (top) and a plot comparing the supernatant solids content of a latex-TiO₂ system without surfactant (“No Surfactant”, orange) and with 1.0% high molecular weight phosphate surfactant (“C24P”, blue) (bottom).

FIG. 15 shows exemplary polyolefin dispersions.

FIG. 16 shows images of carbon black dispersions in water (left) and treated with high molecular weight sulfonate surfactant in water (right) after two weeks.

FIG. 17 shows percent latex association with TiO₂ as a function of pH.

FIG. 18A shows SEM of dried latex-TiO₂ coating systems employing latex SDS-Lat2 treated with high molecular weight phosphate surfactant.

FIG. 18B shows SEM of dried latex-TiO₂ coating systems employing latex SDS-Lat2 treated with high molecular weight phosphate surfactant.

### DETAILED DESCRIPTION

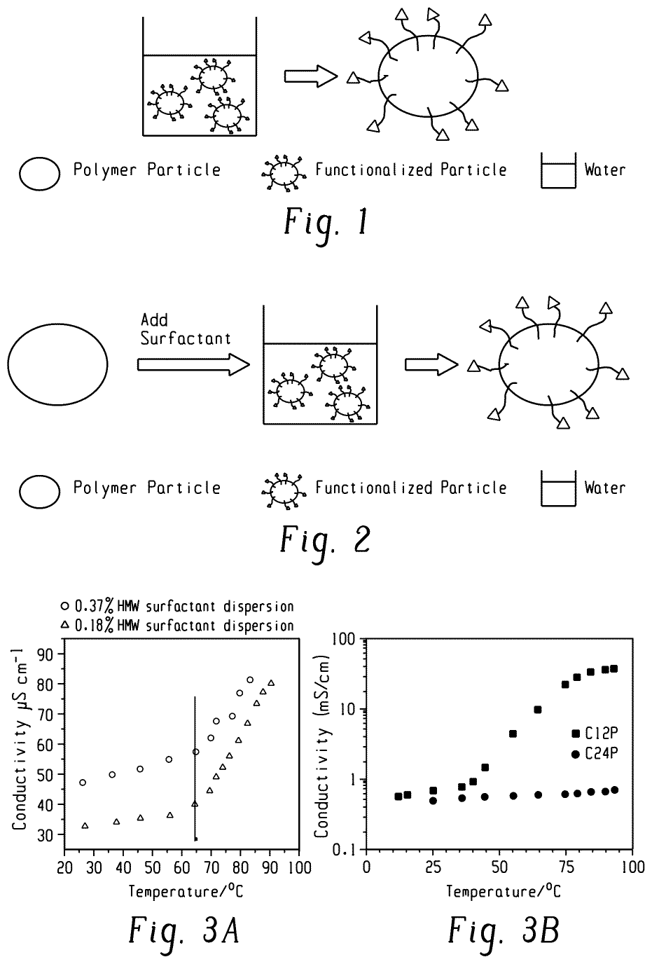

The present inventors have discovered a method for the preparation of polymer particle and inorganic particle dispersions, where the particles of the dispersions comprise a particular functionality which can advantageously be incorporated using functional surfactants. Surfactants useful in the present disclosure are substantially water-insoluble at room temperature. The present inventors have further found that the dispersions which are particularly useful as coating compositions, where the constituent polymer particles of the dispersions comprise a particular functionality which can advantageously be incorporated using functional surfactants. Through careful selection of the functional surfactants, the surfactants can adsorb to the surface of the particles, thereby incorporating the desired functionality on the particle surface and allowing them to form useful coatings, optionally in combination with inorganic particles (so called “hybrid coating compositions”). In the case of polymer particles, such a method precludes the need for functional co-monomers incorporated during polymerization, which can introduce complexity and cost to the process. These functional surfactants adhere strongly to the particles and do not readily desorb and can surprisingly be added during a polymerization process (as shown schematically in FIG. 1) or to pre-formed polymer or inorganic particles (as shown schematically in FIG. 2) even though they are water insoluble. The substantially water insoluble surfactants surprisingly transfer from dispersed surfactant domains onto the polymer or inorganic particle surface. Upon cooling they remain on the particle surface. This invention allows a significant simplification of the formation of functional dispersions, facilitating the formulation of functionalized dispersions using low cost precursors by simple and cost-effective measures.

Accordingly, one aspect of the present disclosure is a dispersion. The dispersion comprises a plurality of polymer particles, a plurality of inorganic particles, or a combination thereof dispersed in an aqueous solution, wherein the polymer particles and the inorganic particles are substantially insoluble in the aqueous solution. In an embodiment, the dispersion comprises a plurality of polymer particles dispersed in the aqueous solution. In another embodiment, the dispersion comprises a plurality of inorganic nanoparticles dispersed in the aqueous solution.

As used herein, “substantially insoluble” means that the particles have a solubility in the aqueous solution of less than 1%, or less than 0.5%, or less than 0.1%. Preferably, the polymer particles are insoluble in the aqueous solution.

The aqueous solution comprises water. In some embodiments, the aqueous solution is water, preferably deionized water. In some embodiments, the aqueous solution can be an aqueous buffered solution. The aqueous solvent can have a pH of 1 to 12, for example 4 to 8.

The polymer particles of the dispersion can comprise an acrylate polymer, a styrenic polymer, a vinyl polymer, a polyolefin, a polyurethane, an epoxy, an alkyd polymer, or a combination comprising at least one of the foregoing. In an embodiment, the polymer particles comprise an acrylate polymer, a polyolefin, a polyurethane, an alkyd polymer, or a combination thereof. In some embodiments, the polymer particles comprise an acrylate polymer comprising poly(butyl acrylate), poly(methyl methacrylate), poly(butyl acrylate)-co-poly(methyl methacrylate), or a combination comprising at least one of the foregoing. In a specific embodiment, the polymer particles comprise poly(butyl acrylate)-co-poly(methyl methacrylate). In some embodiments, the polymer particles comprise a polyolefin. Polyolefins include polyethylenes (including high density polyethylene (HDPE), low density polyethylene (LDPE), medium density polyethylene (MDPE), and linear low density polyethylene (LLDPE)), polypropylenes (including atactic, syndiotactic, and isotactic polypropylenes), and polyisobutylenes. Polyolefins and methods for their preparation are known in the art and are described for example in U.S. Pat. No. 2,933,480 to Gresham et al., U.S. Pat. No. 3,093,621 to Gladding, U.S. Pat. No. 3,211,709 to Adamek et al., U.S. Pat. No. 3,646,168 to Barrett, U.S. Pat. No. 3,790,519 to Wahlborg, U.S. Pat. No. 3,884,993 to Gros, U.S. Pat. No. 3,894,999 to Boozer et al., and U.S. Pat. No. 4,059,654 to von Bodungen. In some embodiments the polyolefin consists essentially of a polyolefin homopolymer. Polyolefins can also include ethylene/alpha-olefin copolymers, such as copolymers of ethylene and 1-butene, copolymers of ethylene and 1-hexene, and copolymers of ethylene and 1-octene. Polyolefins can also include ethylene/acrylate copolymers, such as copolymers of ethylene and acrylic acid.

The polymer particles can have an average particle diameter of less than or equal to 1000 nanometers (nm). For example, the polymer particles can have an average particle diameter of 10 to 1000 nm, or 10 to 1000 nm, or 10 to 800 nm, or 10 to 600 nm, or 10 to 500 nm, or 25 to 500 nm, or 50 to 400 nm. Average particle diameter can be determined, for example, by light scattering methods.

The inorganic particles of the dispersion can comprise titanium dioxide, iron oxide, chrome oxide, zinc oxide, zinc sulfide, aluminates, silicates, zinc ferrite, clay (including, silicate-based, aluminum-based, and/or ferruginous-based clays, specifically, kaolin clay, nepheline syenite, bentonite, and the like), mica, talc, calcium carbonate, silica, feldspar, or a combination comprising at least one of the foregoing. In some embodiments, the inorganic particles can be titanium dioxide particles, carbon black particles, or a combination thereof. In some embodiments, the inorganic particles can be titanium dioxide particles.

The inorganic particles can have an average particle diameter of 10 nm to 50 micrometers (μm). Within this range, the inorganic particles can have an average diameter of 10 to 1000 nm, or 10 to 500 nm, or 10 to 300 nm, or 20 to 150 nm, or 50 to 300 nm, or 100 to 300 nm, or 150 to 300 nm, or 200 to 300 nm, or 225 to 275 nm. Also within this range, the inorganic particles can have an average particle diameter of 500 nm to 50 μm or 1 to 50 μm.

The particles of the dispersion each comprise a surface, and at least a portion of the surface (of each particle) comprises one or more functional surfactants disposed on the surface of the particle. For example, the one or more functional surfactants can be adsorbed to the surface of the particles. Advantageously, the functional surfactants are not covalently bound to the surface of the particle. Rather, the functional surfactants are adhered to or embedded in the surface of the particles by non-covalent interactions. Such non-covalent interactions can include but are not limited to high affinity or low affinity site-specific type interactions, non-bonded electrostatic interactions such as electropositive or electronegative type or van der Waals repulsive and attractive forces, ionic bonds, hydrogen bonds, coordination bonds, or a combination thereof.

Functional surfactants useful in the present disclosure are those which comprises a C₁₈₋₃₂ alkyl group and at least one functional group comprising a sulfonate group, a phosphate group, a ureido group, an acetoacetoxy group, a carboxylate group, a C₁₋₁₂ fluorocarbon group, a zwitterionic group, a polyether group, a sugar group (e.g., a polyglycoside), a quaternary ammonium group, or a combination comprising at least one of the foregoing. In some embodiments, the functional surfactant comprises a sulfonate group or a phosphate group. In some embodiments, the surfactant can have a molecular weight of at least 265 grams per mole, or at least 270 grams per mole, or at least 275 grams per mole, or at least 280 grams per mole, or at least 285 grams per mole, or at least 290 grams per mole.

In some embodiments, the surfactants useful in the present disclosure have surfactant tail groups with HLBs of less than or equal to 1, or less than or equal to 0, or less than or equal to −0.5, or less than or equal to −1.5, or less than or equal to −4, or 1 to −6, or 0 to −6, or −0.5 to −6, or −0.5 to −5, or −0.5 to −4, as determined using Davie's Equation:

$$HLB = 7 + {\sum }_{i = 1}^{m} {H}_{i} - n \times 0.475$$

As used herein, the term “surfactant tail group” refers to the entirety of the surfactant except for the functional end group (e.g., the phosphate group, the sulfonate group, hydroxyl group etc). In Davie's Equation, where m is the number of hydrophilic groups in the molecule, Hᵢ is the value of the i^{th} hydrophilic group and n is the number of lipophilic groups in the molecule, as described in Davies J T (1957), “A quantitative kinetic theory of emulsion type, I. Physical chemistry of the emulsifying agent” (PDF), Gas/Liquid and Liquid/Liquid Interface, Proceedings of the International Congress of Surface Activity, pp. 426-38, incorporated herein by reference. Here, for example. ethoxylate groups correspond to an Hi value of 0.33 and benzene groups have an assumed effective HLB contribution equivalent to 3.5-6.0 methylene groups (i.e. n=3.5 to n=6.0).

In some embodiments, the surfactants useful for the present disclosure can have a high Krafft temperature. For example, exemplary surfactants can have a Krafft temperature of at least 50° C. In some embodiments, the surfactant does not exhibit a Krafft temperature up to 90° C., or up to 95° C., or up to 100° C. Krafft temperature can be determined by, for example, measuring electrical conductivity in water at various temperatures, where the Krafft temperature is taken to be the inflection point when conductivity is plotted against temperature.

Functional surfactants useful in the present disclosure are substantially water insoluble at room temperature (e.g., 20-25° C.). As used herein, “substantially water insoluble” means that less than 0.5 parts by weight of the functional surfactants can dissolve in 100 parts by weight of water. Alternatively, “substantially water insoluble” means that the functional surfactants can have a water solubility of less than 5 milligram per milliliter.

In some embodiments, the dispersion can exclude or minimize any surfactant other than the functional surfactants defined herein. In some embodiments, the dispersion excludes or minimizes (e.g., includes less than 5 wt %, or less than 1 wt %, or less then 0.1 wt %) surfactants having a molecular weight of 260 grams per mole or less. In some embodiments, the dispersion can exclude any surfactant that is not soluble in the aqueous solution, for example at a temperature of 60 to 100° C., or 70 to 100° C., or 80 to 100° C. In some embodiments, the dispersion can minimize or exclude any surfactant that is soluble in the aqueous solution at a temperature of 25° C. (i.e., any surfactant where more than 10 parts by weight of the surfactant can be dissolved in 100 parts by weight of water). In some embodiments, the dispersion can minimize or exclude a polyoxyalkylene surfactant. For example a polyoxyalkylene surfactant can be present in an amount of less than 1 weight percent, or less than 0.1 weight percent, or less than 0.01 weight percent, each based on the total weight of the dispersion, preferably wherein polyoxyalkylene surfactants are excluded from the dispersion.

In some embodiments, the functional surfactant is present on the surface of the particles in an amount of 0.1 to 10 weight percent, based on the weight of the particles.

In some embodiments, the dispersion comprises 50 to 99 weight percent of the solvent; 1 to 50 weight percent of the polymer particles, the inorganic nanoparticles, or combination thereof; and 0.01 to 5 weight percent of the functional surfactant; wherein weight percent of each component is based on the total weight of the dispersion. In some embodiments, when present, the inorganic particles can be present in an amount of 1 to 50 weight percent, based on the total weight of the coating composition.

Another aspect of the present disclosure is a method of making the dispersion. In some embodiments, particularly when the dispersion is a polymer dispersion comprising polymer particles, the method comprises forming the polymer particles in the presence of the functional surfactant. Forming the polymer particles can be by polymerizing the corresponding monomer in the presence of an initiator to provide the polymer particles. Preferably, the initiator is a hydrophilic free radical initiator, for example, sodium or potassium persulfate, or a nonionic, water-soluble initiator such as 2′-azobis[2-methyl-N-(2-hydroxyethyl)propionamide]. For example, the polymer particle can be formed using well-known emulsion polymerization processes. Preferably, no functional co-monomers are used in the polymerization. The desired functionality on the surface of the polymer particles is preferably only due to non-covalent interactions of the functional surfactant and the polymer particle (e.g., by adsorption, as enmeshed or embedded functional surfactant on the surface of the polymer particle, or any other means of non-covalent attachment).

In some embodiments, the method comprises dispersing a plurality of polymer particles or inorganic nanoparticles or both in water to form a dispersion; and adding the functional surfactant to the dispersion. The functional surfactant can therefore be adsorbed to the pre-formed particles.

Advantageously, the dispersions can exhibit improved stability relative to the corresponding dispersions prepared with low molecular weight surfactants such as sodium dodecyl sulfate, sodium dodecyl phosphate, and the like. For example, the dispersions can be stable at a pH of less than or equal to 3. Stated another way, the dispersion can exhibit no visible coagulation (observed by eye) at a pH of less than or equal to 3.

The dispersions described herein can be useful for a variety of applications including, but not limited to, coating compositions, cosmetics, cosmeceuticals, drug delivery, controlled release systems, biosensors, bioimaging, food stabilization, semiconductors, ceramics, nutraceuticals, packaging application, seed coatings, pesticide formulations, and the like.

In a specific aspect the dispersions can be useful in coating compositions. Accordingly, another aspect of the present disclosure is a coating composition comprising a dispersion. The dispersion can be as described above. In an aspect, the coating composition comprises a dispersion comprising a plurality of polymer particles dispersed in an aqueous solution, wherein the polymer particles are substantially insoluble in the aqueous solution. In another embodiment, the coating composition can optionally further comprise a plurality of inorganic nanoparticles dispersed in the aqueous solution to provide a hybrid polymer/inorganic coating composition, as will be discussed in detail below.

The dispersion can be prepared according to the methods described herein. In some embodiments, the coating composition comprises inorganic particles, the functionalized polymer dispersions can be added to the inorganic particles to provide hybrid inorganic/organic particle dispersions, which can provide improved coating properties.

The coating composition can comprise the dispersion in an amount of 15 to 99.99 weight percent, based on the total weight of the coating composition.

In addition to the dispersion, the coating composition can optionally further comprise one or more additives, with the proviso that the one or more additives do not significantly adversely affect the desired properties of the dispersion. Additives can include, but are not limited to, for example, colorants, fillers, thickening agents, surfactant, biocides, defoamers, and combinations comprising at least one of the foregoing.

In some embodiments, the coating composition can further comprise a colorant, such as a pigment or dye additive. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments.

Dyes are generally organic materials and include coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or combinations comprising at least one of the foregoing dyes.

In some embodiments, the coating composition can further comprise a thickening agent. Thickening agents (or “thickeners”) are generally used to control the rheological properties of the coating compositions (e.g., paint formulations) from the manufacture process through storage and application. Various types can be used, including associative, non-associative, and thixotropes. Thickeners described as non-associative (i.e., do not bind to particles present in the dispersion) are usually soluble cellulosic polymers, such as hydroxyethylcellulose. Associative thickeners include hydrophobically modified cellulosic polymers, hydrophobically-modified alkali-swellable emulsion polymers, and hydrophobically-modified ethoxylated polyurethane resins. Clay or organo-modified clay thickeners, often referred to as thixotropes, can also be used to control certain rheological properties.

In some embodiments, the coating composition can further comprise a surfactant (i.e., in addition to the surfactant of the dispersion). Surfactants can aid in wetting dry pigment particles during the manufacture process. Surfactants also stabilize the dispersion against flocculation in the coating composition and provide the composition with compatibility with tinting dispersions, which are often added by the end user. Nonionic surfactants and anionic surfactants are commonly used. Many commonly used nonionic surfactants are alkyl aryl polyethers. Examples of anionic surfactants include salts of phosphate esters, and alkyl aryl polyether sulfate salts.

In some embodiments, the coating composition can further comprise a biocide. Biocides are typically included in compositions to provide resistance to microorganisms. Biocides can be incorporated at different stages of the manufacture process, however they are commonly added in the last steps to decrease their exposure to high temperature or potential deactivating reagents. In some embodiments, the biocide can be a water-insoluble biocide. By “water-insoluble” is meant a solubility in water of 0.5 wt % or less, more preferably 0.25 wt % or less, and even more preferably, 0.1 wt % or less, at 25° C. Examples of suitable biocides can include, for example, 1,2-benzisothiazol-3(2H)-one (BIT), ortho-phenyl phenol (OPP), alkylisothiazolinones such as octylisothiazolinone (OTT), 3-iodo-2-propynyl-butylcarbamate (IPBC), carbendazim (2-benzimidazolecarbamic acid, methyl ester), chlorothalonil (1,3-dicyanotetrachlorobenzene), diuron (1,1-dimethyl-3-(3,4-dichlorophenyeurea), azole-based antimicrobials such as tebuconazole (C-2-(4-chlorophenyl)-ethyl O-(1,1-dimethylethyl)-1H-1,2,4-triazole-l-ethanol), propiconazole (1-2-(2,4-dichlorophenyl)-4-propyl-1,3-dioxolan-2-yl)methyl)-1H-1,2,4-triazole), and azaconazole (1-2-(2,4-dichlorophenyl)-1,3-dioxolan-2-yl)methyl)-1H-1.2.4-triazole), thiabendazole (2-(1,3-Thiazol-4-yl)-1Hbenzimidazole; 2-(4′-thiazolyl)benzimidazole), Zinc pyrithione, diiodomethyl-para-tolylsulfone, 2-(thiocyanomethylthio)benzthiazole, zinc dimethyldithiocarbamate, Triclosan (2′,4′,4-trichloro-2-hydroxydiphenyl ether), cybutrin (2-(tert-butylamino)-4-(cyclopropylamino)-6-(methylthio)-1,3,5-triazine), terbutryn (2-ethylamino-4-methylthio-6-tertbutylamino-1,3,5-triazine), N-alkyl-substituted BIT such as N-butyl-BIT, dihalo-substituted alkylisothiazolinones such as dichlorooctylisothiazolinone (DCOIT), and mixtures of two or more thereof. A particularly suitable biocide is BIT.

In some embodiments, the coating composition can further comprise a defoamer. Defoamers can be added at various times during the manufacturing process to prevent foam formation. Most defoamers are either silicone-based, or mineral oil-based, and some contain hydrophobic silica.

The additives can be present in the coating composition in an amount of 0.01 to 85 weight percent, based on the total weight of the coating composition.

A coating can be prepared by disposing the coating composition on a surface, and drying the coating for a time and at a temperature sufficient to effect evaporation of the solvent. As can be readily determined by one of skill in the art, the time and temperature needed to effect evaporation of the solvent can vary slightly depending on the particular composition of the coating composition. In some embodiments, the coating is disposed on an article, (i.e., on a surface of an article). For example, the surface can comprise wood, metal, ceramic, brick, stone, concrete, glass, plastic, or a combination thereof.

The invention is further illustrated by the following non-limiting examples.

### EXAMPLES

### Synthesis and Characterization of High Molecular Weight Sulfonate Surfactant (HMWSS)

HMWSS was prepared by an extraction and neutralization process from a C₂₀₋₂₄ alkyl benzene sulfonate surfactant, commercially available as ARISTONIC Acid 9900 available from Pilot Chemical Company. ¹H NMR was used to characterize the neutralized HMWSS, an alkylbenzene sulfonate, to determine the number of carbons in the two alkyl chains of the HMWSS. From the ¹H NMR, it was determined that each alkyl chain of the HMWSS contained, on average, 22 carbons.

### Synthesis and Characterization of High Molecular Weight Phosphate Surfactant (HMWPS)

HMWPS was synthesized by a phosphorylation reaction between polyphosphoric acid and a C₂₄ Guerbet alcohol. The product was neutralized with sodium carbonate, separated through liquid-liquid extraction, and the composition of the product was analyzed via quantitative phosphorus nuclear magnetic resonance spectroscopy (³¹P qNMR). The resulting neutralized phosphate product was approximately 80% mono ester with the remaining composition having a phosphate di- and tri- ester, phosphate, and pyrophosphate.

### Krafft Temperature and Solubility

Krafft Temperature, the temperature at which an ionic surfactant begins to form micelles in water, is marked by a significant increase in solubility and therefore electrical conductivity for ionic surfactants. Electrical conductivities of the HMW Surfactant species were measured in water at various temperatures to determine Krafft Temperature.

As shown in FIG. 3A, the Krafft Temperature of the HMWSS is approximately 65° C. In contrast, the sodium dodecyl sulfate has a Krafft Temperature of roughly 15° C. Similarly, FIG. 3B shows a Krafft Temperature of roughly 40° C. for sodium dodecyl phosphate while HMWPS does not exhibit a definitive Krafft Temperature up to The high Krafft Temperatures of the high molecular weight surfactant species of the present examples demonstrates the role of temperature in solubility of these surfactant species. The HMW surfactants exhibit high Krafft temperatures, particularly relative to the corresponding lower molecular weight derivatives (e.g., SDS), and show increased solubility with increased temperature.

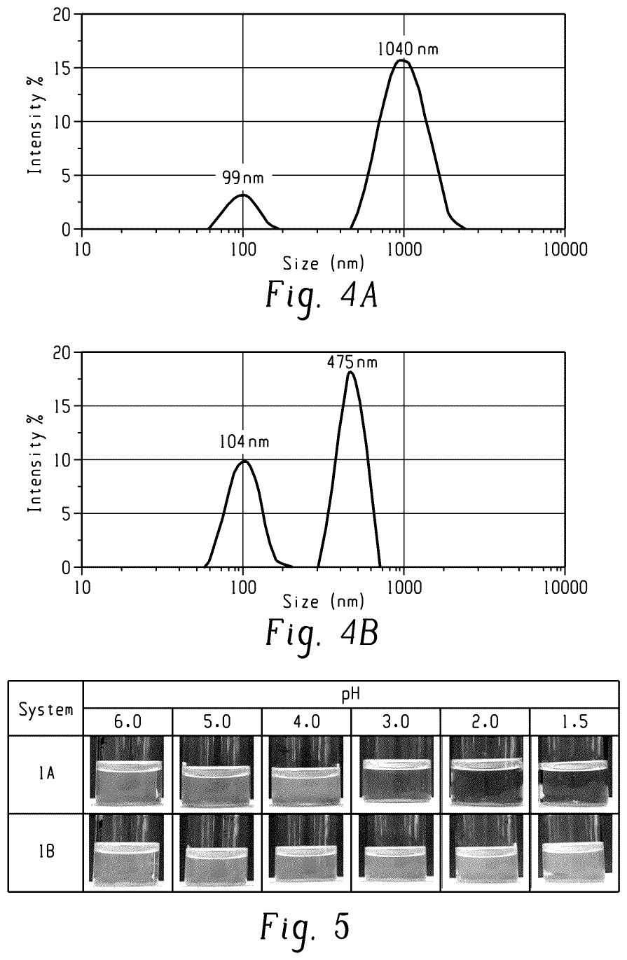

To further analyze the effect of temperature on the present dispersions, two samples HMWPS were dispersed in water according to the following: 1) HMWPS+water+mixing at room temperature for 90 minutes, and 2) surfactant+water+mixing at 80° C. for minutes. After 14 days, the systems were visually compared and particle size in the supernatants were measured by dynamic light scattering (DLS). The surfactant that was not heated predominantly settled to the bottom while the heated surfactant remained dispersed. FIG. 4 depicts particle size distributions of the supernatant phases for both systems. Significantly, the overall size domains were observed to be 1040 and 99 nanometers (nm) in the unheated sample, and only 475 and 104 nm in the heated sample. Thus the heating process enables long term dispersion of surfactant and higher populations of smaller size domains than what results from mixing only (no heat).

### Synthesis of Surfactant-Free and Surfactant-Containing Latex

A surfactant-free latex consisting of methyl methacrylate (MMA) and butyl acrylate (BA) was synthesized as a model latex for studying adsorption of the high molecular weight surfactants. Methacrylic acid (MAA) was used to stabilize the latex. A nonionic initiator, specifically 2,2′-Azobis[2-methyl-N-(2-hydroxyethyl)propionamide], was used in the latex syntheses to avoid any further addition of ionic groups on the surface of the latex. Emulsion polymerization was used to produce the latex and this surfactant-free latex is referred to a SF-Lat1. The components of SF-Lat1 can be found in Table 1.

TABLE 1

| | MMA | BA Content | MAA | Particle | Theoretical | Experimental |
|---|---|---|---|---|---|---|
| | Content (g) | (g) | Content (g) | Size (nm) | wt % polymer | wt % polymer |
| SF-Lat1 | 2.02 | 2.70 | 0.050 | 200 | 10.6 | 8.6 |

A series of model latexes containing small amounts of sodium dodecyl sulfate (SDS) were synthesized to obtain smaller polymer nanoparticles with higher polymer content for eventual functionalization with the high molecular weight surfactants. Various latexes were generated with HMWSS and HMWPS to demonstrate the application of the surfactant in emulsion polymerization. A nonionic initiator, specifically 2,2′-Azobis[2-methyl-N-(2-hydroxyethyl)propionamide], was used in the latex syntheses to avoid any further addition of ionic groups on the surface of the latex. Table 2 provides a summary of the latexes synthesized with the high molecular weight surfactants.

TABLE 2

| | Surfactant | Surfactant | MMA | BA | Particle | Theoretical | Experimental |
|---|---|---|---|---|---|---|---|
| | Species | Content (g) | Content (g) | Content (g) | Size (nm) | wt % polymer | wt % polymer |
| SDS-Lat1 | SDS | 0.2 | 7.5 | 2.5 | 203 | 20 | 14.4 |
| SDS-Lat2 | SDS | 0.225 | 45 | 30 | 180 | 50.8 | 35.3 |
| SDS-Lat3 | SDS | 0.675 | 45 | 30 | 90 | 50.8 | 37.9 |
| HMWS-Lat1 | HMWSS | 0.2 | 7.5 | 2.5 | 220 | 20 | 18.9 |
| HMWP-Lat1 | SDS, | 0.225, 0.75 | 45 | 30 | 165 | 50.8 | 36 |
| | HMWPS | | | | | | |

The ability of the high molecular weight surfactant to adsorb to preformed latex particles was tested. The systems chosen to functionalize were SF-Lat1 (Table 1) and SDS-Lat2 (Table 2), which contain 0% and 0.3% SDS, respectively. The systems are stabilized mainly by carboxylate groups from methacrylic acid (MAA) used during synthesis. A latex of interest was heat treated at 80° C. in presence of a given surfactant for 90 minutes while mixing to functionalize the polymer particles. The resulting system was tested for stability by aliquoting latex samples into aqueous hydrochloric acid (HCl (aq.)) at various pH's.

### Dispersion Stability

FIG. 5 shows the results of the stability test of “System 1A” corresponding to SF-Lat1 without HMWSS, and “System 1B” corresponding to SF-Lat1 heat treated with 0.3 weight percent HMWSS. Significantly, System 1A coagulates at pH 3 while System 1B maintains stability down to pH 1.5. The adsorbed sulfonate surfactant, which is reported to have a pKa below 0, in System 1B provides stability from acidic environment while the carboxylate groups, with pKa values of approximately 4.5, become protonated at lower pH's and therefore do not provide enough repulsion between polymer particles to induce stability. This test demonstrates the stability induced by the adsorption of HMWSS on the polymer surface.

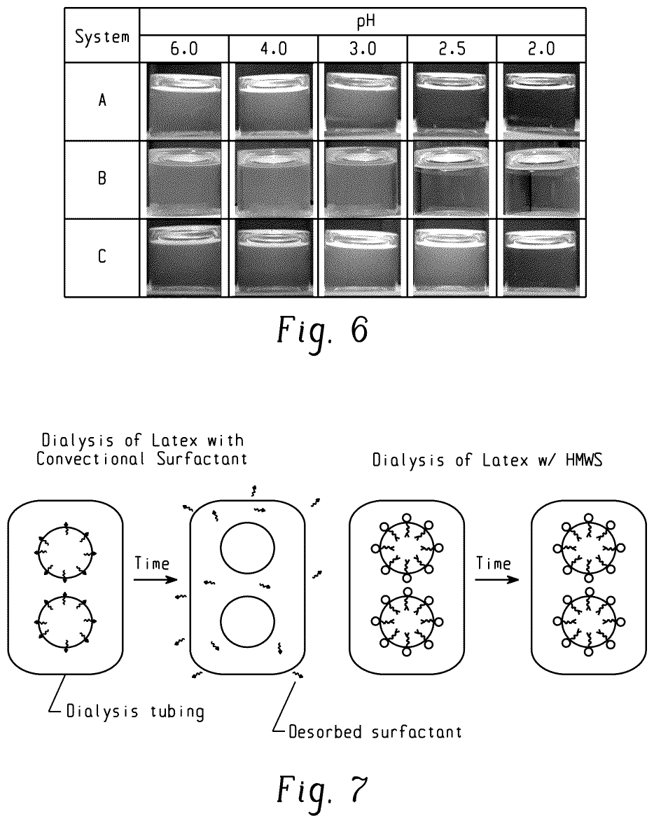

Similarly, FIG. 6 depicts the stability test of a “System 2A” corresponding to SDS-Lat2 without added surfactant, “System 2B” corresponding to SDS-Lat2 heat treated with sodium dodecyl phosphate, and “System 2C” corresponding to “SDS-Latex2” heat treated with HMWPS. Note that approximately the same molar composition of sodium dodecyl phosphate and HMWPS were used for Systems 2B and 2C, respectively. Systems 2A and 2B were observed to coagulate at pH 2.5 while System 2C maintains stability until pH 2.0. The adsorbed HMWPS, with an expected primary pKa of 2.0 and a secondary pKa of 7.0, enables stability at lower pH's compared to the carboxylate groups of System 2A. Significantly, the coagulation of System 2B, which is a lower molecular weight analog of HMWPS, does not provide stability for the polymer system. This retained stability may be due to an increased adsorption strength of the HMWPS compared to sodium dodecyl phosphate. Without wishing to be bound by theory, it is believed that an increased adsorption strength is a result of the longer alkyl chains in the HMWPS and therefore heightened van der Waals forces.

These results suggest that the HMWPS transfers to the latex even below the Krafft temperature, which is a unique and previously unreported transfer of surfactant from water insoluble domains onto polymer particle surface in an aqueous system.

Dialysis was also performed on the latex systems treated with high molecular weight surfactant species and a lower molecular weight analogue in order to demonstrate the increased adsorption strength of high molecular weight surfactant compared to a conventional surfactant. This process is shown schematically in FIG. 7.

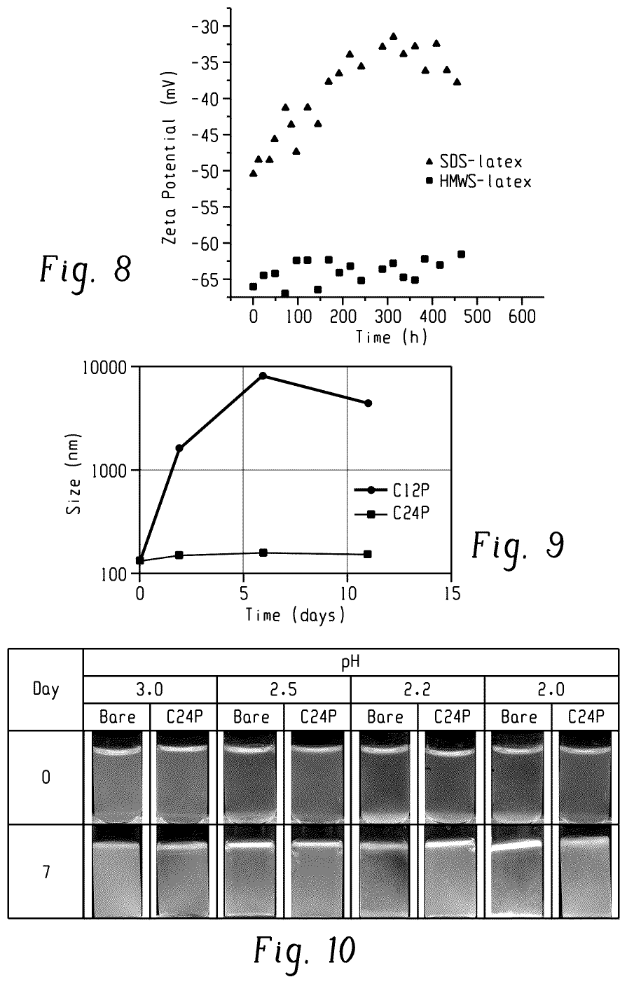

In one experiment, the following groups were compared: 1A) SF-Lat1 treated with SDS, and 1B) SF-Lat1 heat treated with HMWSS. The same molar composition of SDS and HMWSS was used based on 0.3 wt % HMWSS treatment with respect to polymer mass. Zeta potential of each latex was measured over the course of approximately 500 hours. As seen in FIG. 8, the zeta potential of System 1A rises quickly from its initial value while System 1B maintains its zeta potential over the entire time course. Without wishing to be bound by theory, it is believed that this is likely due to the migration of SDS away from the polymer surface while the HMWSS remains strongly bound to the particle therefore maintaining its surface charge (i.e. zeta potential).

In another experiment, two latex systems were produced: 2A) SDS-Lat2 treated with sodium dodecyl phosphate and 2B) SDS-Lat2 heat treated with HMWPS. System 2B was functionalized with 1.0 wt % HMWPS, with respect to polymer mass, and the same molar composition of sodium dodecyl phosphate was used to functionalize System 2A. Particle size was measured after functionalization in HCl (aq.) at pH 3 via dynamic light scattering (DLS). The two systems were placed in separate dialysis tubing and dialyzed over the course of 11 days in deionized (DI) water. DI water was replaced once daily. As can be seen from FIG. 9, the particle sizes of both systems were the same on Day 0. However, on Day 2, System 2A is no longer stable in a pH 3 system as evidenced by a significant particle size growth. On the other hand, System 2B experienced a minimal particle size increase of roughly 15 nm. Significantly, stability of System 2B was maintained over the 11 day trial.

Without wishing to be bound by theory, it is believed that the longer alkyl chains of high molecular weight surfactants cause an increased adsorption strength of surfactant to the polymer surface. The adsorption strength of surfactant is believed to be imparted by a combination of 1) heightened van der Waals forces between the alkyl chain and polymer surface, and 2) the low solubility of the high molecular weight surfactant in aqueous environments.

Latex systems were incubated and mixed at 140° F. over the course of two weeks. Two systems were compared: 1) untreated SDS-Lat2 and 2) SDS-Lat2 treated with HMWPS. Once weekly, the latex systems were tested for particle stability at various pH's.

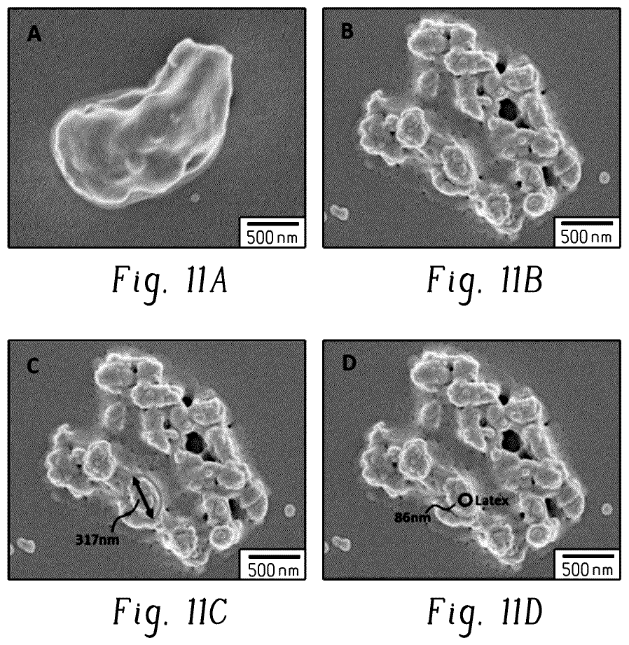

As can be seen in FIG. 10, System 1 coagulates at pH 2.5 while System 2 remains stable until pH 2.2. Additionally, after one week, 56 wt % of the polymer aggregated in System 1 while 0% aggregated in System 2. After two weeks, 96% and 92% of System 1 and System 2 aggregated, respectively. The results from this study demonstrate that high molecular weight surfactant adsorbs to emulsion polymers and enables longer particle stability at elevated temperatures.

Functionalized polymers were shown to associate with pigment, observed by scanning electron microscopy (SEM). A TiO₂ slurry (Tiona 596 s, 76.5 wt % TiO₂) was added to 1) SDS-Lat1, and 2) SDS-Lat1 treated with HMWPS dropwise via a syringe pump while stirring. The slurry was added to achieve a pigment to binder ratio of 1.2:1 (w/w). SEM was used to observe the particles. A 10 microliter aliquot was pipetted onto a silica wafer. The wafer was attached to an SEM grid using carbon tape. The sample was dried overnight, followed by platinum coating. The sample was scanned at 2.0 kV and 25 pA. The resulting SEM images are shown in FIG. 11.

FIG. 11A, an image of System 1, shows aggregated TiO₂ with little or no associated polymer particles. However, FIG. 11B, an image of System 2, shows a grouping of TiO₂ covered in associated latex particles. FIGS. 11C and 11D shows digital measurements of the pigment measured to be roughly 317 nm with a polymer particle of 86 nm, respectively, in agreeance with particle sizes reported by DLS (i.e. 320 nm and 90 nm, respectively). Importantly, TiO₂ particles in FIG. 11A are not distinct. This is likely a result of TiO₂ that has aggregated with other TiO₂ particles in the absence of functional latex. Conversely, FIG. 11B presents well defined TiO₂ particles with adsorbed latex particles. It is believed that functional latex acts as a spacer between the individual pigment, therefore preventing pigment from clustering with itself.

It was also noted that association of functionalized latex to pigment resulted in an increase of particle size. TiO₂ slurry was added to SDS-Lat2 (System 1), SDS-Lat2 treated with sodium dodecyl phosphate (System 2), and SDS-Lat2 treated with HMWPS (System 3) dropwise via syringe pump while stirring. Note that the molar compositions of surfactant in Systems 2 and 3 were equal. Enough TiO₂ was added to achieve a pigment to binder ratio of 1.2:1 (w/w).

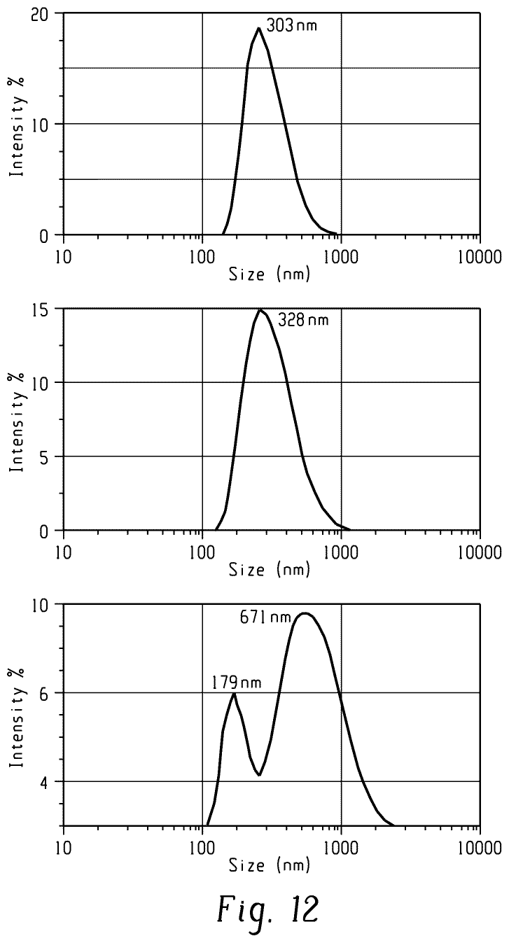

Particle sizes of the samples were measured via DLS and are reported in FIG. 12. FIG. 12 shows a particle size distribution of System 1 (top). Only one peak of 303 nm is presented. System 2, containing sodium dodecyl phosphate, shows a similar distribution with a peak at 328 nm (see FIG. 12, middle). Though the distributions have peaks at 303 and 328 nm, particle sizes 320 nm and 180 nm for the pigment and polymer are contained within the distributions, therefore accounting for un-associated latex and TiO₂. However, when HMWPS functionalized latex was used, two peaks appeared. As shown in FIG. 12 (bottom): one with a particle size of 179 nm and one with a particle size of 671 nm. The theoretical size of an encapsulated pigment is 680 nm for 180 nm polymer particles and 320 nm pigment. The peaks correspond with the theoretical size of polymer-TiO₂ composite particles and free latex.

An experiment was performed to determine the level of latex that associated with TiO₂ as a function of surfactant concentration. HMWPS functionalization concentration was altered from 0.1-5.0 wt % of polymer solids. After encapsulation, samples were centrifuged at 500 relative centrifugal force (rcf) for 4 hours. This speed was chosen because it does not cause sedimentation of the latex alone but causes the TiO₂ and pigment-polymer composite particles to settle quickly. Therefore, latex should only settle if it is associated with pigment. The supernatant and the sediment were weighed, dried, and reweighed to determine solids content of both systems. A larger amount of sediment from a sample is an indication of more latex association. SDS-Lat2 system was treated in varying levels of HMWPS and compared to a given system. It should be noted that all experiments were conducted at small scale (i.e., 10-20 gram batches) with dropwise addition of concentrated TiO₂ slurry.

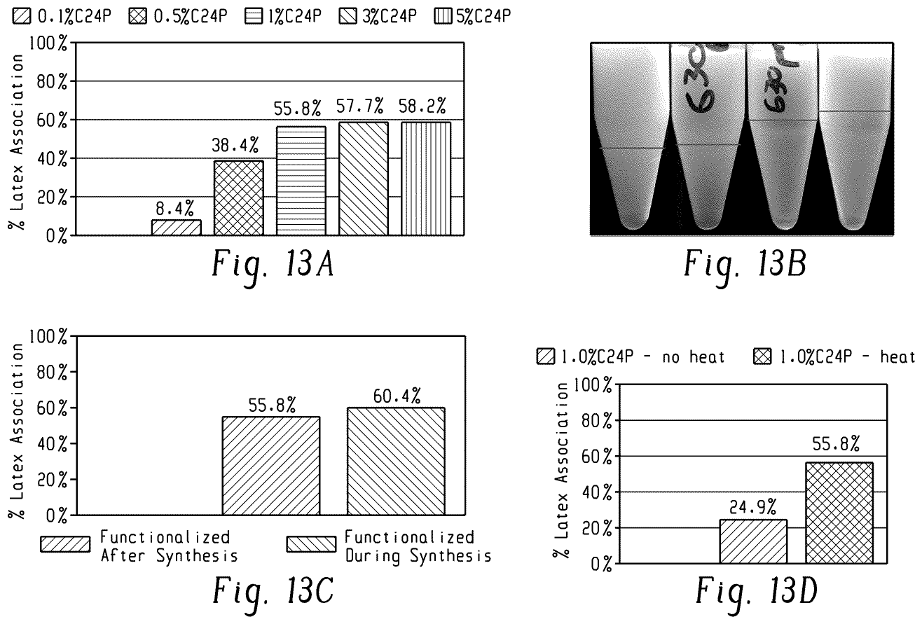

FIG. 13A shows that a maximum latex-pigment association is reached at 1.0 wt % surfactant. However, better mixing profiles could lead to association percentages well above 80%. FIG. 13B shows a visual difference in the level of sedimentation when varying degrees of surfactant are used. This data shows that latex is associating with TiO₂ and is further corroborated by the gravimetric analysis discussed below. Surprisingly, HMWPS functionalizes polymer below its Krafft Temperature.

Polymer association of SDS-Lat2 heat treated with 1.0% HMWPS was compared that of HMWPS-Lat1, which is SDS-Lat2 polymerized in the presence of 1.0% HMWPS. The purpose of this experiment was to determine whether a latex treated with HMWPS after polymerization can achieve similar association percentages as a system functionalized during polymerization. As seen in FIG. 13C, the two systems experienced similar polymer association levels. This result demonstrates that latex functionalized after synthesis can perform as well as latex produced with phosphate surfactant.

In order to demonstrate the importance of heating the surfactant in the functionalization of polymer, a control experiment was run in which HMW surfactant was mixed with latex at room temperature. While some association still occurred, a significant difference in polymer association was realized. Specifically, only 24.9 wt % of polymer associated with an unheated system while 55.8 wt % association was achieved by heating the sample (FIG. 13D). This is more than a 2.2-fold increase in association, likely due to the ability of more surfactant to migrate from a liquid crystal phase onto the polymer particle surface during a heated functionalization process. Better TiO₂ dispersion during association could lead to more TiO₂ surface area available for association with polymer and a further increase in association relative to an unheated sample.

According to Stoke's Law, the settling velocity of a spherical particle is proportional to the difference in density of the particle and the solvent and the square of its radius. Therefore, two particles of different densities and sizes in a given solvent will likely have different settling velocities than that of a composite particle made up of the two individual particles of differing densities. Similarly, it is expected that latex and TiO₂ particles will settle at different rates than polymer-TiO₂ composite particles. The present inventors have used Stoke's Law to demonstrate the theoretical settling velocity of an idealized TiO₂ particle and an idealized encapsulated particle. It is noted that the theoretical encapsulated particle used for these calculations assumes the encapsulating polymer particles adds a homogenous layer of polymer that has a thickness equal to the diameter of the polymer particle.

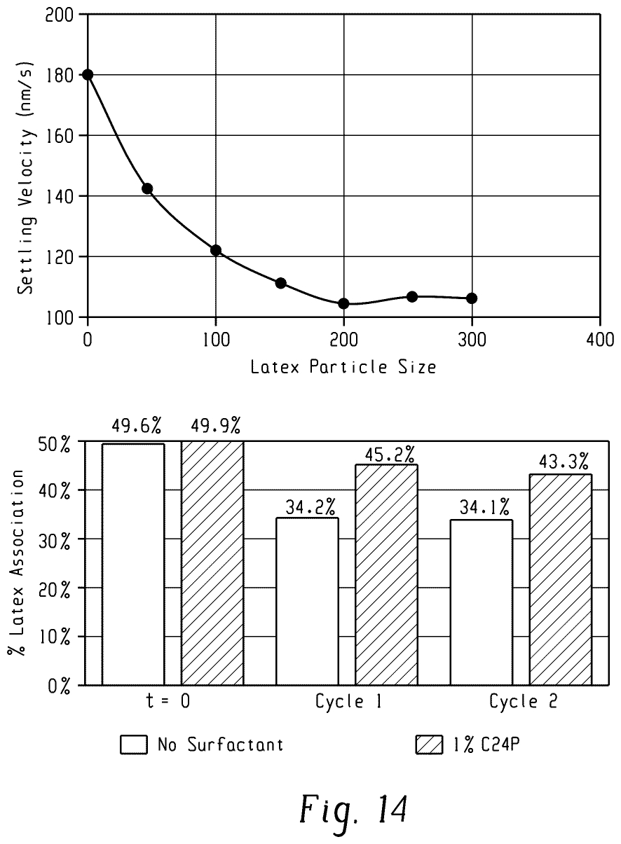

The theoretical settling velocity of idealized composite particles was plotted against the size of the encapsulating latex particle, as seen in FIG. 14 (top), where a 0 nm encapsulating particle is representative of an unassociated TiO₂ particle. FIG. 14A shows a steady decrease in settling velocity from 0 nm to 200 nm with a slight increase in settling velocity from 200 nm to 300 nm. It can be concluded that a theoretical composite particle should settle more slowly than an unencapsulated TiO₂ particle. It is therefore expected that the solids content in the supernatant of an associated system, containing HMWPS treated latex, will decrease more slowly than a control system without HMWPS.

Supernatant solids were measured before and after two centrifugation cycles for two latex systems mixed with TiO_{2:} SDS-Lat2 (System 1) and SDS-Lat2 (System 2) heat treated with HMWPS. FIG. 14 (bottom) shows the supernatant of the HMWPS treated system retains higher solids for a longer period. This result suggests that HMWPS treated latex associates with TiO₂ and causes a slowed settling velocity as anticipated by Stoke's Law. Cycle 1 in FIG. 14 refers to 50 rcf for 1 hr, and cycle 2 refers to 50 rcf+18 hr at regular gravitational force.

### Functionalization of Polyolefin Dispersions

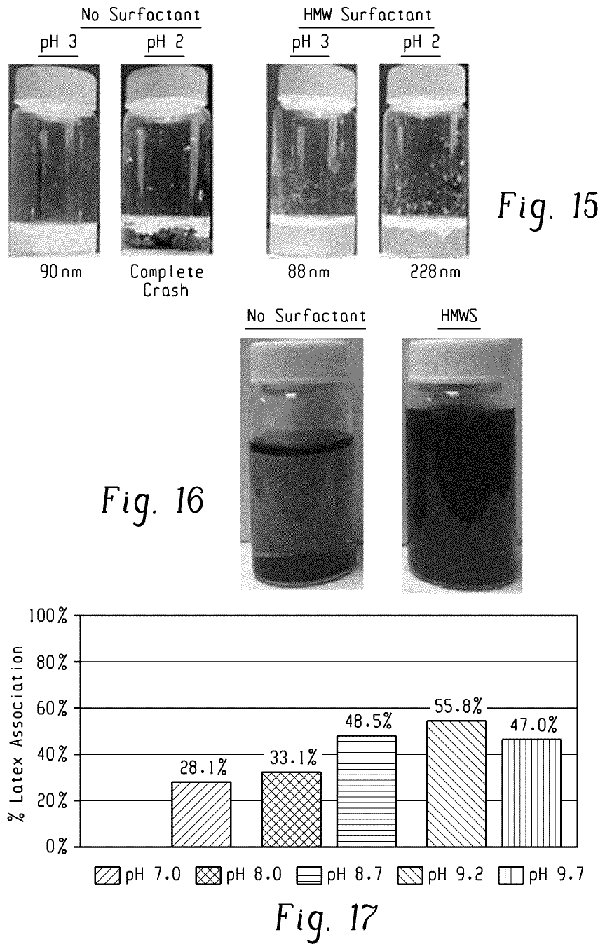

A polyolefin dispersion (POD), made from Primacor 5980I, an ethylene acrylic acid, was functionalized with the HMWSS to demonstrate application of HMW surfactant in various polymer particle systems. For this experiment, a POD was heat treated at 80° C. with 0.5% HMWSS by weight of polymer. A control POD was prepared similarly without HMWSS. A 5 μL sample of each dispersion was aliquoted into 5 mL HCl (aq.) water at pH 3 and pH 2. As can be seen in FIG. 15, the POD systems are stable at pH 3. However, at pH 2 the HMWSS treated POD remained partially stable while the untreated system coagulated. More specifically, a portion of the particles from HMWSS treated POD coagulated, but some remained suspended. DLS was also used to confirm that particles were still suspended at pH 2 in the surfactant treated POD. For the untreated system, no particle size was observed. However, a particle size of 228 nm was observed in the supernatant of the HMWSS treated system.

Similar to the acrylate polymer systems above, this system has been stabilized due to the adsorption of HMWSS. These results suggest that HMW surfactant may be able to functionalize other aqueous polymeric systems such as polyurethane and alkyd dispersions.

### Dispersion of Carbon Black With HMWSS

The ability of HMWSS to functionalize nonpolymeric particles was tested on hydrophobic carbon black. Briefly, 0.003 g of 230 nm carbon black was mixed with 0.19 g of HMWSS in 100 g DI water at 80° C. for 1 hr. After heating, the system was cooled to room temperature. The system was kept in a closed vial at ambient conditions. Visual inspection and DLS were used to verify the stability of the dispersion after 2 weeks. This system was then compared to a control system with no surfactant. From the images of the vials in FIG. 16, it can be observed that particles without surfactant settled while the surfactant treated sample was stable for 2 weeks. The extent of stability was not fully investigated, and it is expected that the carbon black sample remains functional for longer than 2 weeks.

### Optimization of HMW Surfactant on Latex and Non-Latex Surfaces

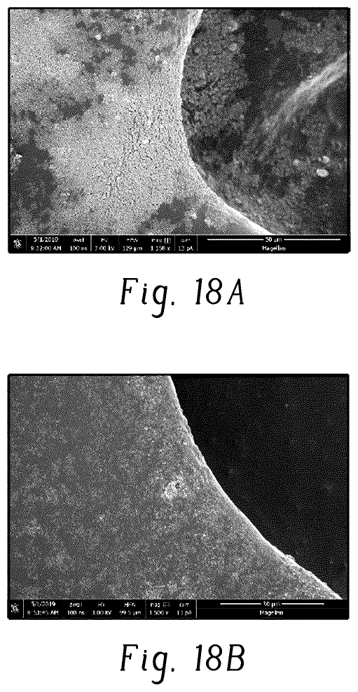

Adsorption of HMWPS was optimized for the TiO₂ association procedure as mentioned above. As previously discussed, a maximum association for this specific system was achieved at 1.0 wt % HMWPS by weight of polymer. This system was used to determine optimal pH condition for association of latex to TiO₂. As can be seen in FIG. 17, a maximum adsorption is realized at pH 9.2.

Thus the present inventors have synthesized new high molecular weight surfactants. The present examples show that temperature has been shown to play a major role in phase behavior of HMW surfactants. Electrical conductivity was used to compare Krafft temperatures of these surfactant species to conventional analogue molecules. The Krafft Temperature of the HMW surfactant species were considerably higher than conventional surfactants and much higher than room temperature. Specifically, the Krafft Temperature of SDS and HMWSS is 15° C. and 65° C., respectively. The Krafft Temperature of sodium dodecyl phosphate is approximately 40° C. while HMWPS did not exhibit a Krafft temperature up to 95° C.

Dispersibility of the HMW surfactant in water was greatly improved through heating processes. In one experiment, HMWPS remained dispersed in an aqueous environment for upwards of 14 days when it was heated during mixing. Contrarily, the unheated control precipitated after just a week. This further shows the significance in temperature on phase behavior of HMW surfactant species.

Various emulsion polymers were produced in order to demonstrate application of HMW surfactant. A surfactant-free latex and latex polymerized with SDS were produced as general examples of polymer particles that HMW surfactant can adsorb to. Both latex systems were tested for stability in various pH's to demonstrate the functionalization with HMW surfactant. HMWSS and HMWPS stabilized latex at lower pH's than control systems not containing HMW surfactant. Importantly, the HMWPS stabilized latex at a lower pH than sodium dodecyl phosphate, a lower molecular weight analogue.

In another experiment, HMWPS was shown to stabilize latex at elevated temperatures (140° C.) for more than 7 days while untreated systems experienced severe coagulation. This result suggests that emulsion polymer can be functionalized and stabilized by strongly adsorbing HMW surfactant over an extended period of time. Importantly, these results also show the functionalization and stabilization of polymer particles with a surfactant (i.e., HMWPS) below its Krafft Temperature.

Emulsion polymer functionalized after synthesis with HMWPS associated with TiO₂ pigment. SEM of HMWPS treated latex mixed with TiO₂ revealed polymer particles associated to pigment and well dispersed pigment. Gravimetric analysis showed polymer association percentages higher than 55%. Stoke's Law calculations predicted that association of polymer should slow sedimentation of TiO₂. Gravimetric analysis revealed a slowed settling when HMWPS treated latex was mixed with TiO₂. Heating HMWPS in the presence of latex was shown to cause a 2.2-fold increase in latex association compared to an unheated control.

HMWSS was also used to functionalize a POD made up of Primacor 5980I. The resulting POD was stable at lower pH's than an untreated POD. This is a significant result that suggests PODs, as well as polyurethane and alkyd dispersions, could be functionalized after synthesis and/or preparation and potentially associate with pigment.

HMWSS was also used to disperse hydrophobic carbon black in water for more than 2 weeks. This is a significant result that suggests that nonpolymeric systems may be functionalized with the high molecular weight surfactant.

### Formation of Coating

Two latex-TiO₂ systems were developed to form a model coating. System 1 contained SDS-Lat2 and System 2 contained SDS-Lat2 treated with HMWPS. TiO₂ was added to the latex systems at a pigment to binder ratio of 1.2:1 (w/w). Films were formed from the resulting systems and imaged using SEM.

From FIG. 18A, one can see that the untreated latex system produced a film which has an abundance of TiO₂ on the surface with large pigment clusters. However, when HMWPS treated latex is used in coatings, the TiO₂ is well dispersed (see FIG. 18B). It also appears that less TiO₂ breaches the coating surface in HMWPS treated system. This is likely a result of the HMWPS treated latex preventing the TiO₂ from aggregating by associating with the pigment. Better dispersion of pigment in coatings may lead to improved opacity and mechanical properties.

The invention includes at least the following embodiments, which are non-limiting.

Embodiment 1: A dispersion comprising a plurality of polymer particles, a plurality of inorganic particles, or a combination thereof dispersed in an aqueous solution, wherein the polymer particles, the inorganic particles, or the combination thereof are substantially insoluble in the aqueous solution; wherein one or more functional surfactants are disposed on at least a portion of a surface of the polymer particle or the inorganic particle; wherein each functional surfactant comprises a C₁₈₋₃₂ alkyl group; and at least one functional group comprising a sulfonate group, a phosphate group, a ureido group, an acetoacetoxy group, a carboxylate group, a C₁₋₁₂ fluorocarbon group, a zwitterionic group, a polyether group, a sugar group, a quaternary ammonium group, or a combination comprising at least one of the foregoing.

Embodiment 2: The dispersion of embodiment 1, wherein the dispersion comprises a plurality of polymer particles.

Embodiment 3: The dispersion of embodiments 1 or 2, wherein the polymer particles comprise an acrylate polymer, a styrenic polymer, a vinyl polymer, a polyolefin, a polyurethane, an epoxy, an alkyd polymer, or a combination comprising at least one of the foregoing.

Embodiment 4: The dispersion of any of embodiments 1 to 3, wherein the polymer particles comprise an acrylate polymer comprising poly(butyl acrylate), poly(methyl methacrylate), poly(butyl acrylate)-co-poly(methyl methacrylate), or a combination comprising at least one of the foregoing.

Embodiment 5: The dispersion of any of embodiments 1 to 4, wherein the polymer particles comprise poly(butyl acrylate)-co-poly(methyl methacrylate).

Embodiment 6: The dispersion of embodiment 1, wherein the dispersion comprises a plurality of inorganic particles.

Embodiment 7: The dispersion of embodiment 6, wherein the inorganic nanoparticles comprise titanium dioxide, iron oxide, chrome oxide, zinc oxide, zinc sulfide, aluminates, silicates, carbon black, zinc ferrite, nepheline syenite, bentonite, clay, mica, talc, calcium carbonate, silica, kaolin clay, feldspar, or a combination comprising at least one of the foregoing.

Embodiment 8: The dispersion of any of embodiments 1 to 7, wherein the inorganic nanoparticles comprise titanium dioxide, carbon black, or a combination thereof.

Embodiment 9: The dispersion of any of embodiments 1 to 8, wherein the surfactant is substantially water insoluble at a temperature of 20 to 25° C.

Embodiment 10: The dispersion of any of embodiments 1 to 9, wherein the surfactant has a surfactant tail group with an HLB of less than or equal to 1.

Embodiment 11: The dispersion of any of embodiments 1 to 10, wherein the functional surfactant comprises a sulfonate head group or a phosphate head group.

Embodiment 12: The dispersion of any of embodiments 1 to 11, wherein the polymer particles have an average particle diameter of less than or equal to 1000 nanometers.

Embodiment 13: The dispersion of any of embodiments 1 to 12, wherein the inorganic particles have an average particle diameter of 10 nm to 50 μm.

Embodiment 14: The dispersion of any of embodiments 1 to 13, wherein the functional surfactant has a molecular weight of at least 265 grams per mole.

Embodiment 15: The dispersion of any of embodiments 1 to 14, wherein the functional surfactant is present on the surface of the particles in an amount of 0.1 to 10 weight percent, based on the weight of the polymer particles.

Embodiment 16: The dispersion of any of embodiments 1 to 15, wherein the dispersion comprises: 50 to 99 weight percent of the aqueous solution; 1 to 50 weight percent of the polymer particles, the inorganic particles, or combination thereof; and 0.01 to 5 weight percent of the functional surfactant; wherein weight percent of each component is based on the total weight of the dispersion.

Embodiment 17: The dispersion of embodiment 16, wherein the polymer particles are present, and the polymer particles comprise poly(butyl acrylate)-co-poly(methyl methacrylate), ethylene acrylic acid copolymer, or a combination thereof.

Embodiment 18: The dispersion of embodiment 16, wherein the inorganic particles are present, and the inorganic particles comprise titanium dioxide, carbon black, or a combination thereof.

Embodiment 19: A method of making the dispersion of any of embodiments 1 to 18, the method comprising: forming a polymer particle in the presence of the functional surfactant.

Embodiment 20: A method of making the dispersion of any of embodiments 1 to 18, the method comprising: dispersing a plurality of polymer particles, a plurality of inorganic particles, or a combination there of in water to form a dispersion; and adding the functional surfactant to the dispersion.

Embodiment 21: A coating composition comprising a dispersion, the dispersion comprising: a plurality of polymer particles dispersed in an aqueous solution, wherein the polymer particles are substantially insoluble in the aqueous solution; wherein one or more functional surfactants are disposed on at least a portion of a surface of the polymer particle; wherein each functional surfactant comprises a C₁₈₋₃₂ alkyl group; and at least one functional group comprising a sulfonate group, a phosphate group, a ureido group, an acetoacetoxy group, a carboxylate group, a C₁₋₁₂ fluorocarbon group, a zwitterionic group, a polyether group, a sugar group, a quaternary ammonium group, or a combination comprising at least one of the foregoing.

Embodiment 22: The coating composition of embodiment 21, further comprising a plurality of inorganic particles.

Embodiment 23: The coating composition of embodiments 21 or 22, wherein the polymer particles comprise an acrylate polymer, a styrenic polymer, a vinyl polymer, a polyolefin, a polyurethane, an epoxy, an alkyd polymer, or a combination comprising at least one of the foregoing.

Embodiment 24: The coating composition of any of embodiments 21 to 23, wherein the polymer particles comprise an acrylate polymer comprising poly(butyl acrylate), poly(methyl methacrylate), poly(butyl acrylate)-co-poly(methyl methacrylate), or a combination comprising at least one of the foregoing.

Embodiment 25: The coating composition of any of embodiments 21 to 24, wherein the polymer particles comprise poly(butyl acrylate)-co-poly(methyl methacrylate).

Embodiment 26: The coating composition of any of embodiments 22 to 25, wherein the inorganic nanoparticles comprise titanium dioxide, iron oxide, chrome oxide, zinc oxide, zinc sulfide, aluminates, silicates, carbon black, zinc ferrite, nepheline syenite, bentonite, clay, mica, talc, calcium carbonate, silica, kaolin clay, feldspar, or a combination comprising at least one of the foregoing.

Embodiment 27: The coating composition of any of embodiments 22 to 26, wherein the inorganic nanoparticles comprise titanium dioxide, carbon black, or a combination thereof.

Embodiment 28: The coating composition of any of embodiments 21 to 27, wherein the functional surfactant comprises a sulfonate group or a phosphate group.

Embodiment 29: The coating composition of any of embodiments 21 to 28, wherein the polymer particles have an average particle diameter of less than or equal to 1000 nanometers.

Embodiment 30: The coating composition of any of embodiments 22 to 29, wherein the inorganic particles have an average particle diameter of 10 nm to 50 μm.

Embodiment 31: The coating composition of any of embodiments 21 to 30, wherein the functional surfactant has a molecular weight of at least 265 grams per mole.

Embodiment 32: The coating composition of any of embodiments 21 to 31, wherein the surfactant is substantially water insoluble at a temperature of 20 to 25° C.

Embodiment 33: The coating composition of any of embodiments 21 to 32, wherein the surfactant has a surfactant tail group with an HLB of less than or equal to 1.

Embodiment 34: The coating composition of any of embodiments 21 to 33, wherein the functional surfactant is present on the surface of the particles in an amount of 0.1 to 10 weight percent, based on the weight of the polymer particles.

Embodiment 35: The coating composition of any of embodiments 21 to 34, wherein the dispersion comprises: 50 to 99 weight percent of the aqueous solution; 1 to 50 weight percent of the polymer particles; and 0.01 to 5 weight percent of the functional surfactant; wherein weight percent of each component is based on the total weight of the dispersion.

Embodiment 36: The coating composition of embodiment 35, wherein the polymer particles comprise poly(butyl acrylate)-co-poly(methyl methacrylate), ethylene acrylic acid copolymer, or a combination there.

Embodiment 37: The coating composition of embodiment 35 or 36, further comprising inorganic particles, and the inorganic particles comprise titanium dioxide, carbon black, or a combination thereof.

Embodiment 38: The coating composition of any of embodiments 21 to 37, further comprising one or more additives.

Embodiment 39: The coating composition of any of embodiments 21 to 38, further comprising a colorant.

Embodiment 40: The coating composition of any of embodiments 38 or 39, wherein the additive is present in an amount of 0.01 to 85 weight percent, based on the total weight of the coating composition.

Embodiment 41: A coating derived from the coating composition of any of embodiments 21 to 40, wherein the coating is disposed on at least a portion of a surface of an article, preferably wherein the surface of the article comprises wood, metal, ceramic, brick, stone, concrete, glass, plastic, or a combination thereof.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A dispersion comprising
a plurality of polymer particles, a plurality of inorganic particles, or a combination thereof dispersed in an aqueous solution, wherein the polymer particles, the inorganic particles, or the combination thereof are substantially insoluble in the aqueous solution;
wherein one or more functional surfactants are disposed on at least a portion of a surface of the polymer particle or the inorganic particle;
wherein each functional surfactant comprises
a C₁₈₋₃₂ alkyl group; and
at least one functional group comprising a sulfonate group, a phosphate group, a ureido group, an acetoacetoxy group, a carboxylate group, a C₁₋₁₂ fluorocarbon group, a zwitterionic group, a polyether group, a sugar group, a quaternary ammonium group, or a combination comprising at least one of the foregoing.

2. The dispersion of claim 1, wherein the dispersion comprises a plurality of polymer particles, wherein the polymer particles comprise an acrylate polymer, a styrenic polymer, a vinyl polymer, a polyolefin, a polyurethane, an epoxy, an alkyd polymer, or a combination comprising at least one of the foregoing.

3. The dispersion of claim 1, wherein the polymer particles comprise an acrylate polymer comprising poly(butyl acrylate), poly(methyl methacrylate), poly(butyl acrylate)-co-poly(methyl methacrylate), or a combination comprising at least one of the foregoing.

4. The dispersion of claim 1, wherein the dispersion comprises a plurality of inorganic particles having an average particle diameter of 10 nm to 50 μm comprising titanium dioxide, iron oxide, chrome oxide, zinc oxide, zinc sulfide, aluminates, silicates, carbon black, zinc ferrite, nepheline syenite, bentonite, clay, mica, talc, calcium carbonate, silica, kaolin clay, feldspar, or a combination comprising at least one of the foregoing.

5. The dispersion of claim 1, wherein the surfactant is substantially water insoluble at a temperature of 20 to 25° C.

6. The dispersion of claim 1, wherein the surfactant has
a surfactant tail group with an HLB of less than or equal to 1;
a sulfonate head group or a phosphate head group; and
a molecular weight of at least 265 grams per mole.

7. The dispersion of claim 1, wherein the functional surfactant is present on the surface of the particles in an amount of 0.1 to 10 weight percent, based on the weight of the polymer particles.

8. The dispersion of claim 1, wherein the dispersion comprises:
50 to 99 weight percent of the aqueous solution;
1 to 50 weight percent of the polymer particles, the inorganic particles, or combination thereof; and
0.01 to 5 weight percent of the functional surfactant;
wherein weight percent of each component is based on the total weight of the dispersion.

9. The dispersion of claim 8, wherein
the polymer particles comprise poly(butyl acrylate)-co-poly(methyl methacrylate), ethylene acrylic acid copolymer, or a combination thereof; and
the inorganic particles are present, and the inorganic particles comprise titanium dioxide, carbon black, or a combination thereof.

10. A method of making the dispersion of claim 1, the method comprising:
forming a polymer particle in the presence of the functional surfactant; or
dispersing a plurality of polymer particles, a plurality of inorganic particles, or a combination there of in water to form a dispersion; and
adding the functional surfactant to the dispersion

11. A coating composition comprising a dispersion, the dispersion comprising:
a plurality of polymer particles dispersed in an aqueous solution, wherein the polymer particles are substantially insoluble in the aqueous solution;
wherein one or more functional surfactants are disposed on at least a portion of a surface of the polymer particle;
wherein each functional surfactant comprises
a C ₁₈₋₃₂ alkyl group; and
at least one functional group comprising a sulfonate group, a phosphate group, a ureido group, an acetoacetoxy group, a carboxylate group, a C₁₋₁₂ fluorocarbon group, a zwitterionic group, a polyether group, a sugar group, a quaternary ammonium group, or a combination comprising at least one of the foregoing.

12. The coating composition of claim 11, further comprising a plurality of inorganic particles comprising titanium dioxide, iron oxide, chrome oxide, zinc oxide, zinc sulfide, aluminates, silicates, carbon black, zinc ferrite, nepheline syenite, bentonite, clay, mica, talc, calcium carbonate, silica, kaolin clay, feldspar, or a combination comprising at least one of the foregoing.

13. The coating composition of claim 11, wherein the polymer particles comprise an acrylate polymer, a styrenic polymer, a vinyl polymer, a polyolefin, a polyurethane, an epoxy, an alkyd polymer, or a combination comprising at least one of the foregoing.

14. The coating composition of claim 11, wherein the functional surfactant comprises a sulfonate group or a phosphate group, has a molecular weight of at least 265 grams per mole, is substantially water insoluble at a temperature of 20 to 25° C., and has a surfactant tail group with an HLB of less than or equal to 1.

15. The coating composition of claim 11, wherein the functional surfactant is present on the surface of the particles in an amount of 0.1 to 10 weight percent, based on the weight of the polymer particles.

16. The coating composition of claim 11, wherein the dispersion comprises:
50 to 99 weight percent of the aqueous solution;
1 to 50 weight percent of the polymer particles; and
0.01 to 5 weight percent of the functional surfactant;
wherein weight percent of each component is based on the total weight of the dispersion.

17. The coating composition of claim 11, further comprising an additive, wherein the additive is present in an amount of 0.01 to 85 weight percent, based on the total weight of the coating composition.

18. The coating composition of claim 11, further comprising a colorant.

19. A coating derived from the coating composition of claim 11, wherein the coating is disposed on at least a portion of a surface of an article.
